(19) United States
(12) Patent Application Publication
(10) Pub. No.: US 2025/0389695 A1
(43) Pub. Date: Dec. 25, 2025

(54) ENVIRONMENTAL SENSING SYSTEMS FOR NON-HUMAN LIVING ORGANISMS AND METHODS THEREOF

(71) Applicant: Metropolitan Acoustics, LLC, Philadelphia, PA (US)

(72) Inventors: Felicia DOGGETT, Philadelphia, PA (US); Julian Plotnick, Philadelphia, PA (US)

(21) Appl. No.: 19/037,124

(22) Filed: Jan. 25, 2025

Related U.S. Application Data
(60) Provisional application No. 63/625,020, filed on Jan. 25, 2024.

(51) Int. Cl. G01N 29/12; G01P 15/09; G01P 15/18

(52) U.S. Cl. CPC G01N 29/12; G01P 15/09; G01P 15/18; G01N 2291/023

(57) ABSTRACT

An environmental sensing unit that includes one or more sensing elements that are coupled to a physical mass morphologically modeled after a non-human living organism is provided. The environmental sensing unit further includes a processing system coupled to said one or more sensing elements to detect environmental factors experienced by the physical mass, determine an environmental sensory profile and output said environmental sensory profile.

### CROSS-REFERENCE TO RELATED APPLICATIONS

This application claims the benefit of priority to U.S. Provisional Application Ser. No. 63/625,020, filed on Jan. 25, 2024. The above application is incorporated herein by reference in entirety.

### TECHNICAL FIELD

The present disclosure relates to the field of environmental monitoring and sensor signal processing.

### BACKGROUND

Environmental conditions have a large impact on animals, and as such accurately accounting for environmental factors in laboratory environments involving animal research can have a significant impact on accuracy of research outcomes and reproducibility of research studies. In particular, the National Institutes of Health (NIH) has prioritized temperature, humidity, vibrations, noise, illumination, odors, and ultrasonic noise as environmental variables that impact the physiological and biological response of animals.

The physiological effects of environmental conditions can significantly impact the outcomes of preclinical and fundamental neuroscience research. In addition to skewing the results of individual study outcomes, the failure to record and publish environmental data affecting experiments can slow down scientific progress for an entire field of research by failing to rule out theories where these environmental factors play a role. In addition to their effects on scientific accuracy, these environmental conditions are factors that are important when considering animal welfare of research animals and livestock.

In particular, vibrations in lab environments have been identified as a significant environmental contaminant for animal research. In addition to the raw level of vibration, the amplitude and frequency distribution of those vibrations have a significant influence on animals. A wide range of environmental vibrations can be perceived by animals, and research has shown that certain amplitudes and frequencies can cause distress or harm to animals while others can be beneficial. This variation makes it especially important to capture the most accurate representation of the environmental vibration that an animal would experience. Animal researchers have identified that environmental monitoring is the best way to account for the differences between research environments and to understand the harmful effects of environmental conditions on lab animals.

Current means of measuring the vibrational environment only capture a distorted or incomplete version of what an animal would experience. In some systems, accelerometers attached to truck beds are used to measure the vibration levels of transportation environment for livestock. In other systems, Accelerometers are attached to mouse cages to capture the vibration of the cage environment for research. Other devices have taken advantage of biomimicry primarily for locomotion and robotics, such as a mouse-inspired robot. However, the state of the art for monitoring environmental factors for animal research fails to take into account the movement of the body of the animal. Thus, it is a challenge to design a device with significant improvement in measuring and understanding the environmental factors as experienced by animals in these environments while also considering the overall vibration amplification and damping caused by the bodies of the animals. Therefore, what is needed in the art is an improved environmental monitoring system that accounts for vibrations affected by the bodies of animals.

### SUMMARY

The following brief summary is not intended to include all features and aspects of the examples of this technology illustrated and described herein and is merely a summary of examples of the present disclosure. Examples of this technology relate to systems for environmental sensing for non-human living organisms, and methods of manufacturing said environmental sensing systems.

According to an example of the present disclosure, an environmental sensing system for non-human living organisms is provided. The environmental sensing system comprises a physical mass morphologically modelled after at least a part of a non-human living organism to mimic at least one attribute of the non-human living organism. The environmental sensing system further comprises at least one sensing element coupled to and configured to measure an effect of at least one environmental factor on the physical mass. The at least one sensing element is configured to output the one or more measurements of the effect of the least one environmental factor on the physical mass to enable a determination of an environmental sensory profile as experienced by the physical mass.

According to an example of the present disclosure, a method of manufacturing an environmental sensing system for non-human living organisms is provided. The method comprises providing a physical mass morphologically modelled after at least a part of a non-human living organism to mimic at least one attribute of the non-human living organism. The method further comprises coupling at least one sensing element to the physical mass, the at least one sensing element configured to measure an effect of at least one environmental factor on the physical mass. The at least one sensing element is configured to output the one or more measurements of the effect of the least one environmental factor on the physical mass to enable a determination of an environmental sensory profile as experienced by the physical mass.

The environmental sensing systems according to the examples of the present disclosure may be advantageous in that said systems allow for a significant improvement in measuring and understanding the vibrations and other environmental factors experienced by non-human animals in target environments by accounting for the overall vibration amplification and damping caused by the bodies of said non-human animals, which have significant implications for animal welfare, and quality and reproducibility of scientific research outcomes. Other features, objects, and advantages will be apparent from the descriptions set forth herein.

### BRIEF DESCRIPTION OF THE DRAWINGS

FIG. 1A is an illustration of an environmental sensing system according to an example of the present disclosure.

FIG. 1B is an illustration of an environmental sensing system according to an example of the present disclosure.

FIG. 1C is an illustration of a Shore Scale according to an example of the present disclosure.

FIG. 1D is an illustration of an environmental sensing system according to an example of the present disclosure.

FIG. 2A-2B are illustrations of an environmental sensing system according to an example of the present disclosure.

FIG. 3A-3B are block diagrams of a sensing system according to an example of the present disclosure.

FIG. 4A-4D are block diagram of a sensing element according to an example of the present disclosure.

FIG. 5 is a block diagram of a sensing element according to an example of the present disclosure.

FIG. 6 is an illustration of an environmental sensing system according to an example of the present disclosure.

FIG. 7 is an illustration of an environmental sensing system according to an example of the present disclosure.

FIG. 8 is an illustration of an environmental sensing system according to an example of the present disclosure.

FIG. 9 is an illustration of an environmental sensing system according to an example of the present disclosure.

FIG. 10 is a flow diagram of a method of manufacture of an environmental sensing system according to an example of the present disclosure.

### DETAILED DESCRIPTION

While the subject matter of the present disclosure is susceptible to various modifications and alternative forms, specific examples thereof have been shown by way of example in the drawings and are herein described in detail. The figures and written description are not intended to limit the scope of the examples of this technology in any manner. Rather, the figures and written description are provided to illustrate the examples of this technology to a person skilled in the art.

Physical systems will amplify vibrations acting upon them at their resonant frequencies. These frequencies are determined primarily by material properties such as mass, stiffness, elasticity, size, shape, and weight distribution. Calculating the resonant frequency (Fn) of a system can be complicated, but a simplified model can be predicted using the equation Fn=1/(2*π)*√(k/m), where k is the stiffness constant and m is the mass. For structures like buildings and bridges, this can lead to swaying or cracking when exposed to vibrations at those frequencies, while musical instruments of different shapes and sizes will produce the strongest vibrations when played at multiples of their resonant frequencies (harmonics). In addition to amplification of vibrations at resonant frequencies, objects also experience reduced vibrations or damping at certain frequencies due to external forces acting upon them, such as friction and gravity.

In the case of an animal being exposed to environmental vibrations, different parts of an animal will vibrate at different frequencies, i.e., head, abdomen, and limbs will each vibrate individually from each other to some extent, but since they are connected, they also contribute to an overall vibrational profile. This approximate set of frequencies within which an animal body is maximally affected by vibrations can be described as a whole-body resonant frequency range (RFR). These ranges have been quantified for several animals, with humans having a resonant frequency between 9-16 Hz, rats between 30-50 Hz, and mice between 40-60 Hz. This range of frequencies indicates what vibration an animal is most sensitive to in general. As the species' body gets progressively larger the resonant frequency range adjusts down accordingly. Reproducing the body's amplification and dampening of incoming vibration frequencies makes a difference when measuring and understanding the impacts of environmental vibrations on said body.

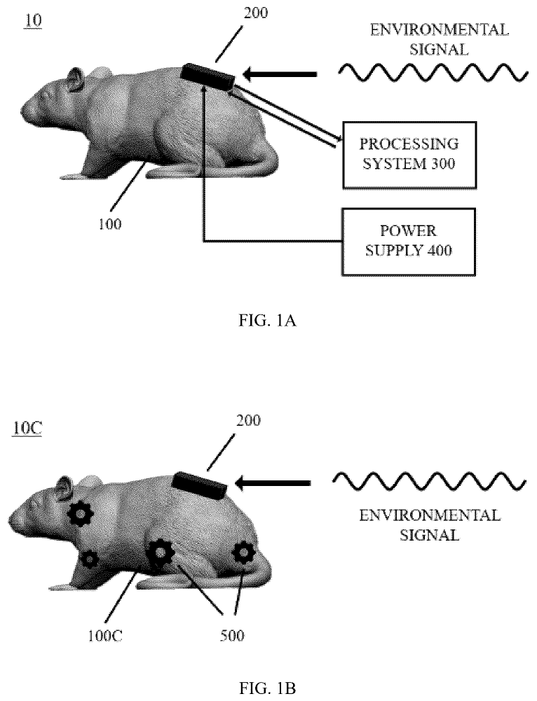

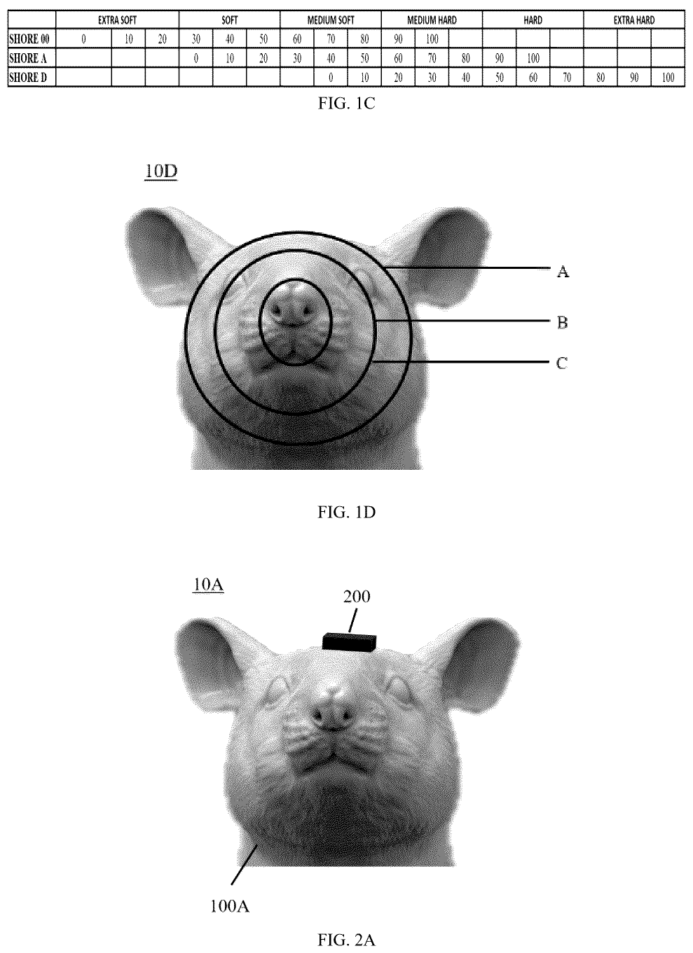

According to an example of the present disclosure, an environmental sensing system for a non-human living organism is provided. FIG. 1A shows an illustration of an environmental sensing system 10 according to this example. The environmental sensing system includes a physical mass 100 that is morphologically modelled after a non-human living organism. For purposes of explanation of the present disclosure, a mouse is used as an exemplary animal, as illustrated in FIG. 1A. However, the physical mass 100 may also be morphologically modelled after other non-human living organisms, such as chicken, fruit fly, worm, rat, zebrafish, frog, rabbit, swine, or non-human primates. The above animals are disclosed as non-limiting examples for the purpose of understanding the present disclosure.

According to this example, the physical mass 100 is particularly modelled when manufactured to replicate the resonant frequency of the body of a mouse. The physical mass 100 may be morphologically modelled to replicate one or more of a size, shape, mass or mass distribution of the mouse and in this example, each is replicated, such as to produce the same resonant frequency as that of the body of a mouse. The physical mass 100 may be modelled to replicate the density of the mouse. The physical mass 100 may be modelled to replicate the flexibility of the mouse. The physical mass 100 may be modelled to replicate the center of gravity distribution of a mouse. The physical mass 100 may be modelled to replicate the mass, stiffness, elasticity, size, shape, and weight distribution of a mouse and so on. The physical mass 100, for example, may be designed to have a specific Shore scale value or a varying range of Shore scale values. The Shore scale will be described below with respect to FIG. 1C. Other physical parameters in the body of a mouse may be replicated in the physical mass 100, as understood by a person of ordinary skill level, to achieve the replication of the resonant frequency produced by the body or in other examples by various body parts of a mouse in the physical mass 100.

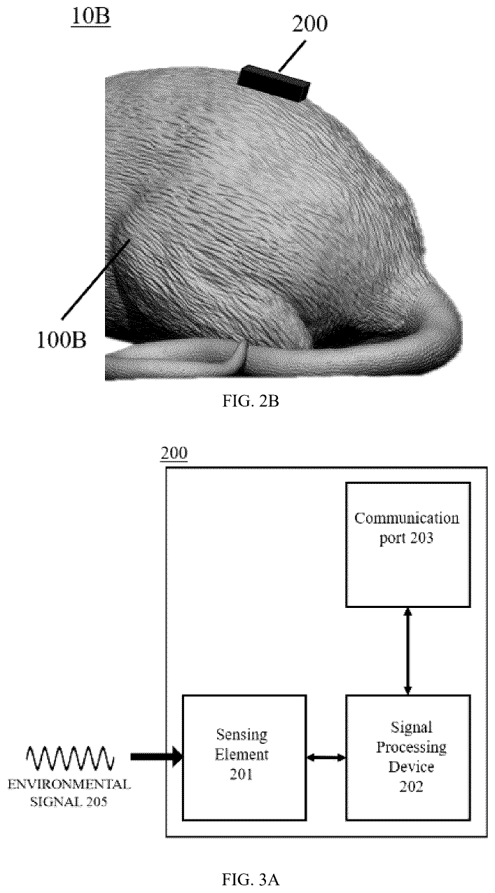

The resonant frequency of the body of the mouse according to this example, may be a single frequency or a range of frequencies. The approximate set of frequencies within which an animal is maximally affected by vibrations can be described as a whole-body resonant frequency range (RFR). The single resonant frequency or RFR replicated for the body of a mouse by the physical mass 100 or in other examples may be for just a portion of the body of the mouse, such as a head or a limb as illustrated in FIG. 2A-2B. Alternatively the resonant frequency or RFR replicated for the body of a mouse by the physical mass 100 may be for all of the body of the mouse. FIG. 2A illustrates an example of a physical mass 100A morphologically modelled after a head of a mouse and FIG. 2B illustrates an example of a physical mass 100B morphologically modelled after a back side of a mouse.

The vibrations discussed herein may also be caused by the movement of the animal under study such as head, limb and body movements. Further, in response to environmental vibrations and movement, standing animals may move and vibrate their limbs in a way to maintain balance and to better recognize and localize specific vibrations. In some examples, the resonant frequency or RFR measured for an animal account for the vibration additionally induced by the movement of the animal. Thus, in some examples, the physical mass 100 morphologically modelled after the body of the mouse as discussed above with respect to FIG. 1A may include an electric Direct Current (DC) motor coupled to and configured to engage automated joints between the head and body, body and limbs, as non-limiting examples, to produce movements mimicking the natural movements produced by the body of the mouse. This is illustrated as DC motors 500 in FIG. 1B. The DC motor may be a brushed DC motor, brushless DC motor, slotless brushless DC motors, stepper motor, micro stepper motor, linear stepper motor or any other motors appreciated by a person of ordinary skill level in the art. The automated joints may comprise electro-mechanical parts configured for movement when engaged by the motor. A control system may be coupled to the motor and the automated joints and may have a processor and memory with programmed instructions for controlling the motor and automated joints to produce movements mimicking the natural movements produced by the body of the mouse or other animate object being modeled.

In some examples, the material of the physical mass 100 may be modelled to recreate several morphological and physiological characteristics of the target animal to mimic the animal's vibrational profile so that the measurements taken from the device more closely match those experienced by the animal, i.e. within asset percentage tolerance, since these physical traits have an impact on the vibration levels which the animal receives from its environment.

In a non-limiting example, the material or materials used for the physical mass 100 is designed to meet specific Shore scale values. FIG. 1C illustrates a Shore scale table quantifying the hardness values into different categories, such as to have the specific Shore scale values for different parts of the physical mass match the specific Shore scale values for the corresponding different parts of the target animal or other object. The hardness of a given material is measured by a durometer. A durometer is a tool designed to measure the hardness of many non-metallic materials, including rubber, vinyl, polyester, leather, nitrile, and neoprene. The durometer is composed of a needle on a spring and a number gauge ranging from 0 to 100. To estimate a given material's Shore hardness scale, the durometer's needle will attempt to penetrate the material. The hardness of the material is determined by measuring its resistance to penetration and any resulting permanent indentation. The pressure of this penetration then activates the gauge on the device, giving a number reading between 0 and 100. Depending on the reading of the gauge and the size of the durometer needle used, the results are classified into certain Shore hardness scales. As illustrated in FIG. 1C, A shore hardness scale quantifies materials on hardness from Extra soft to Extra hard.

In some examples, the material used for the physical mass 100 is designed to have a Shore scale 00value of 60-90 or a Shore scale A value of 30-70 uniformly throughout the physical mass 100. This material may be firm, yet flexible, akin to the body mass of a mouse. In other examples, the physical mass 100 may be modelled in multiple layers with each layer designed to have a different shore scale value range. In one such example, as illustrated in FIG. 1D, the physical mass 100 may include at least three layers. In this example, the third layer C may be the inner most layer away from the surface of the physical mass. A first layer A may be the outer most layer from the surface and a second layer B may be positioned between the first layer and the third layer. The first layer A may be designed to include a Shore scale 00 value 70-80, the second layer B may be designed to include a Shore scale 00 value 80-90, and the third layer C may be designed to include a Shore scale 00 value 60-70. In one example, the material of the physical mass 100 may be designed to include a gradient of Shore Scale 00 values 90-60 from the surface to the center respectively.

In the current example according to the present disclosure, the physical mass 100 may be modelled using a Ballistic gel to closely replicate the physical traits of a mouse. In an alternate example, low-density polyethelene (LPDE) may be used to model the physical mass 100. In yet another alternate example, hydrogels may be used to model the physical mass 100. In another alternate example, an amalgam of water, gelatin, agar, xanthum gum, mineral oil, and citric acid may be used to model the physical mass 100 wherein the levels of the ingredients may be adjusted suitably for achieving any of the one or more physical parameters of the body of the mouse discussed in this disclosure.

In an alternate example, to mimic the vibrational experiences of invertebrates, a hard material with a Shore scale 00 value 90 may be used to produce the physical mass 100 rather than a soft or flexible material with a lower Shore scale value.

Additional components and materials may be added to the physical mass 100, such as synthetic materials that more closely resemble fur, bones, organs and so on, so that the physical mass 100 more closely imitates the vibration of the target animal. As a non-limiting example, materials such as hydroxyapatite, calcium sulfate, tricalcium phosphate and alloplasts may be used to construct bone-like features in the physical mass. As another non-limiting example, synthetic materials that mimic fur such as faux fur made from polyester, modacrylic, acrylic and so on may be processed, dyed, and cut to imitate the texture and color of mouse fur and added to the physical mass 100.

In another aspect of the current example of the present disclosure, referring back to FIG. 1A, a sensing board 200 is coupled to the physical mass 100 morphologically modeled after the mouse. The sensing board 200 is communicatively coupled to a Processing system 300. Further, the sensing board 200 may be powered by an external power supply 400.

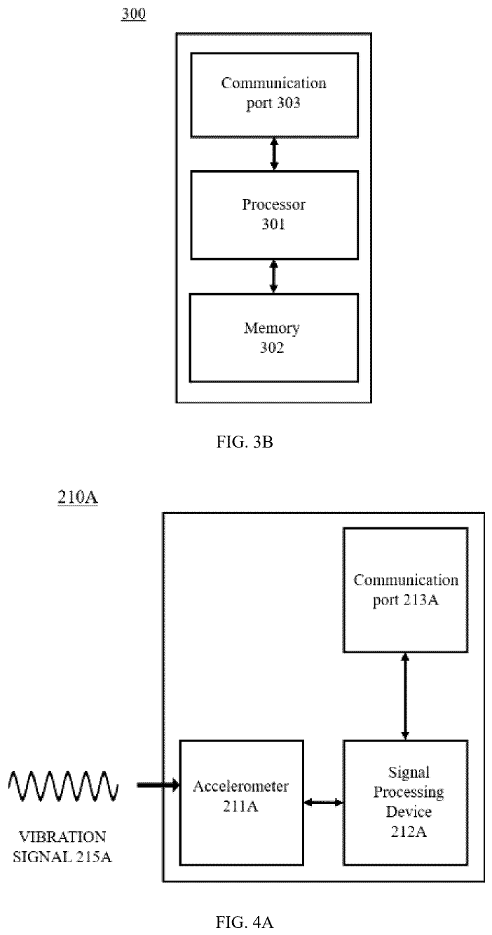

FIG. 3A illustrates a block diagram of an example of the sensing board 200. The sensing board 200 according to the example comprises at least one sensing element 201 that is configured to detect one or more environmental factors 205 experienced by the physical mass 100. The sensing element 201 is configured to convert the environmental factor 205 to a measured effect, such as a voltage or impedance differential proportional to the environmental factor 205 detected. In some examples, the measured effect includes a resonant frequency of the physical mass 100.

The one or more environmental factors 205 may be a physical or chemical signal that may be experienced by the physical mass 100. As non-limiting examples, the environmental factor 205 can include a vibration signal corresponding to the measured vibration, a thermal signal corresponding to the measured temperature, an audio signal corresponding to an average decibel level, a chemical signal corresponding to the captured volatile chemical compounds from odorous items, an ultrasonic signal corresponding to the captured ultrasonic noise, a moisture signal corresponding to the captured humidity, or an optical signal corresponding to the captured brightness level by way of example.

The sensing element 201 may further be coupled to a signal processing element 202 in the sensor board 200. The signal processing element 202 is configured to convert the measured effect from the sensing element 201 into a form suitable for data processing and storage. As a non-limiting example, the signal processing element 202 may include an Analog-to-Digital Converter (ADC) that may use a voltage from a power supply 400 as a reference voltage to convert the measured analog effect into a digital voltage insensitive to the power supply voltage. The above may, in some examples, be accomplished with additional amplifier circuits. As a non-limiting example, the signal processing element 202 may additionally include an analog filter to filter out of band noise and to limit bandwidth. Further, as a non-limiting example, the signal processing element 202 may additionally include a digital filter to filter out noise signals from data signals. As a person of ordinary skill level in the art may appreciate, other signal processing circuitry may be included without deviating from the scope of the disclosure.

The sensing board 200 may further include a communication port 203. In a preferred example, the communication port 203 may include a wireless transceiver with an antenna. The communication port 203 may support one or more wireless communication protocols such as Bluetooth, Bluetooth Low Energy (BLE), LTE, LTE-M, zigbee, Wi-Fi, low frequency and high frequency RFID, LoRaWAN, 6LoWPAN, Z-Wave, NB-IoT, and NFC. In an alternate example, the communication port 203 of sensor board 200 facilitates wired connections.

In another aspect of the current example of the present disclosure, referring back to FIG. 1A, the environmental sensing system 10 includes a processing system 300 coupled to the sensor board 200. According to FIG. 3B, the processing system 300 further comprises a processor 301, a memory 302, and a communication port 303. The sensed data from the sensing element 201 is preferably wirelessly transmitted to the processing system 300 from communication port 203 of the sensing board 200 to communication port 303 of the processing system 300. Alternatively, the sensed data may be transmitted in a wired manner. The memory 302 is configured to store programmed instructions, such as for examples of the executable steps illustrated and described herein, which can be executed by the processor 301. The processor 301, upon executing the programming instructions, receives the measured effect from the sensing element 201 after being processed with the signal processing element 202 and determines an environmental sensory profile based on the measured effect.

The environmental sensory profile may be a visual representation of the data of the measured effect detected by the sensing element 201 in a context understood by human users. As a non-limiting example, the environmental sensory profile may provide a frequency or a range of frequencies in hertz experienced by the physical mass 100 over a set time period. As a non-limiting example, the environmental sensory profile may provide an amplitude of the measured audio wave in volts. As another non-limiting example, the environmental sensory profile may provide a graphical representation of the amplitude of the measured vibrations or a frequency of the measured vibrations or a combination of both. In one aspect of the example, the environmental sensory profile may provide a time domain amplitude response of the measured vibrations and in other aspects, the environmental sensory profile may provide a frequency domain amplitude response of the measured vibrations or a combination of both. As appreciated by one of ordinary skill level in the art, a time domain amplitude response may be a graphical representation of the variation of measured vibration amplitude or audio wave amplitude over a period of time, and a frequency domain amplitude response may be a graphical representation of the variation of measured vibration amplitude or audio wave amplitude over a range of frequencies. In some examples, the environmental sensory profile may provide a heat map from the measured temperatures of the surrounding environment.

The processor 301 may be one or more of microprocessor, microcontroller, digital signal processor (DSP), Application Specific Integrated Circuit (ASIC), Field Programmable Gate Array (FPGA), and discrete logic. The processor 301 may be capable of retrieving and processing instructions, code, and/or data structures for implementing one or more of the examples disclosed herein. As discussed above, the preprogrammed instructions may be stored in a memory 302 in the processing system 300.

The preprogrammed instructions may be a software developed using a specific programming language. Non-limiting examples of programming language include Java, C, C++, Perl, UNIX, Shell, Visual basic script, and JavaScript. In some examples, software applications may be developed using a software development kit provided by a device manufacturer.

In another aspect of the current example of the present disclosure, referring back to FIG. 1A, the environmental sensing system 10 comprises a power supply 400 configured to provide power to the components of the sensing board 200. The power supply 400 may include a power source such as a battery. The power supply 400 may also include a voltage regulator such as one or more of a linear voltage regulator, a buck converter, a boost converter, a buck-boost converter configured to provide a stable voltage across varying load current conditions. In some examples, the power supply 400 may further include a Power Management Integrated Circuit (PMIC) for smart regulation of power.

Although components of the exemplary environmental sensing system 10 are described herein to be configured in a certain manner, other configurations are possible without deviating from the scope of the disclosure. For example, even though the processing system 300 is described as physically positioned outside of the physical mass 100, the processing system 300 may in other examples also be positioned on the physical mass 100 and coupled to the sensor board 200. In some examples, the processing system 300 may also be positioned directly on the sensor board and coupled directly to the sensing element 201 via the signal processing element 202. In some examples, the power supply 400 may also be positioned on the physical mass 100 or on the sensor board itself. The examples explained herein with respect to the figure are intended for ease of understanding of the disclosure and are not meant to be limiting in any manner.

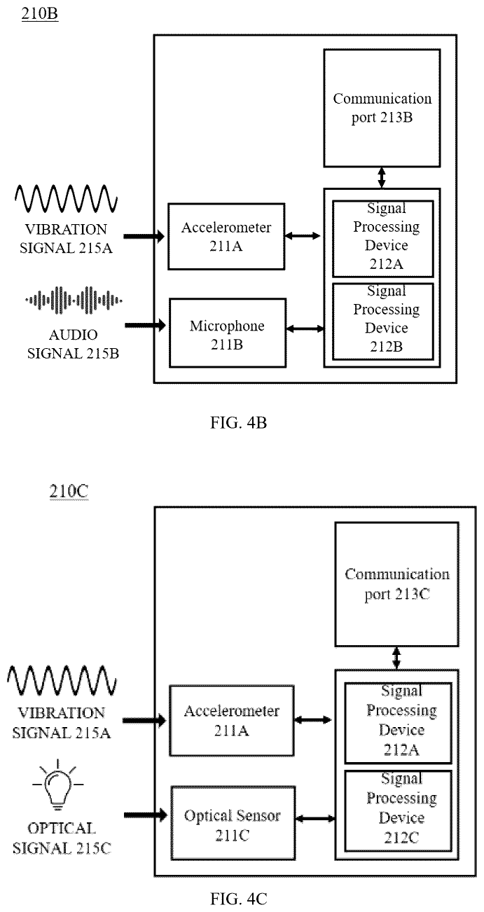

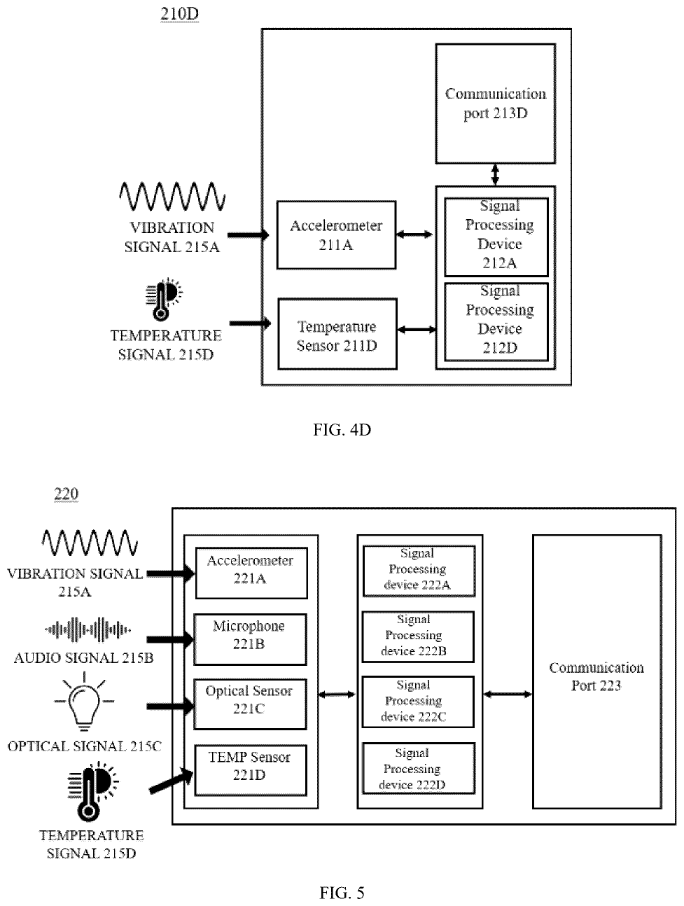

FIG. 4A-4D illustrate block diagrams of various examples of the sensing board coupled to the physical mass 100 described with respect to FIG. 1A. FIG. 4A illustrates an example of the present disclosure including a sensing board 210A that is configured to measure vibration signals 215A from the environment. Vibrations signals 215A may be produced by various aspects of the surrounding environment such as HVAC, fans, elevators, vibrations from outside lab environments such as road noise, airport noise, vibrations caused by movement of human researchers in the lab, lab centrifuge, vibrations from other animals in the lab and so on. The vibration signals 215A may also be caused by the movement of the animal under study, such as head, limb, and body movements of the animal. In some scenarios, the resonant frequency or RFR measured for an animal account for the vibration additionally induced by the movement of the animal. Thus, in some examples, the physical mass 100 morphologically modelled after the body of the mouse as discussed above with respect to FIG. 1A may include a motor coupled to the joints between the head and body, body and limbs, as non-limiting examples, and configured to produce movements mimicking the natural movements produced by the body of the mouse described in the examples above. This is illustrated as DC motor 500 in FIG. 1B.

In an example of the present disclosure, the sensing board 210A further includes a sensing element in the form of an accelerometer 211A. The accelerometer 211A is configured to detect the vibration signals and produce a voltage or impedance differential proportional to the measured vibrations. In an example the measured signal is a resonant frequency as experienced by the physical mass 100. The measured signal may additionally include a range of resonating frequencies as experienced by the physical mass 100 such as RFR. The measured signal may be a resonant frequency or RFR of a portion of the physical mass 100 or the entire physical mass 100. The accelerometer 211A may be a triaxial MicroElectroMechanical Sensor (MEMS) (For example, ADXL355 by Analog Devices). The triaxial MEMS may be configured to provide a voltage or impedance differential proportional to vibrations detected in one or more of three axes or combinations thereof. The triaxial MEMS may create a 3D vector of vibrations to detect lateral, transverse, and rotational vibrations. In some examples, the accelerometer 211A may be a combination of a piezoresistive MEMS accelerometer and a variable capacitive MEMS accelerometer configured to provide a broader frequency response. In some other examples, the accelerometer 211A may be a combination of one MEMS calibrated for low frequencies and another MEMS calibrated for higher frequencies providing a broader frequency response.

The accelerometer 211A may further be coupled to a signal processing element 212A in the sensor board 210A. The signal processing element 212A is configured to convert the voltage or impedance differential proportional to the vibration signals from the accelerometer 211A into a form suitable for data processing and storage. As a non-limiting example, the signal processing element 212A may include an Analog-to-Digital Converter (ADC) that may use a voltage from a power supply 400 as a reference voltage to convert the measured analog voltage or impedance differential into a digital voltage insensitive to the power supply voltage. The above may, in some examples, be accomplished with additional amplifier circuits. As a non-limiting example, the signal processing element 212A may additionally include an analog filter to filter out of band noise and to limit bandwidth. Further, as a non-limiting example, the signal processing element 212A may additionally include a digital filter to filter out noise signals from data signals. As a person of ordinary skill level in the art may appreciate, other signal processing circuitry may be included without deviating from the scope of the disclosure.

The sensing board 210A may further be communicatively coupled to a processing system 300 as explained herein with respect to FIGS. 1A and 3B. The processor 301 receives the measured vibration signals from the accelerometer 211A and determine an environmental sensory profile based on the measured vibration signals. The environmental sensory profile may be a visual representation of the vibration signals 215A detected by the accelerometer 211A in a context understood by human users. The environmental sensory profile may provide a frequency or a range of frequencies in hertz. As another non-limiting example, the environmental sensory profile may provide a graphical representation of the amplitude of the measured vibrations or a frequency of the measured vibrations or a combination of both. In one aspect of the example, the environmental sensory profile may provide a time domain amplitude response of the measured vibrations and in other aspects, the environmental sensory profile may provide a frequency domain amplitude response of the measured vibrations or a combination of both. As appreciated by one of ordinary skill level in the art, a time domain amplitude response may be a graphical representation of the variation of measured vibration amplitude over a period of time, and a frequency domain amplitude response may be a graphical representation of the variation of measured vibration amplitude over a range of frequencies. In some examples, the environmental sensory profile may provide a visual map of the vibration patterns in the environment surrounding the physical mass.

FIG. 4B illustrates an example of the present disclosure including a sensing board 210B. The sensor board 210B retains the same processing system 300 and power supply 400 as described above in the example with respect to FIGS. 1A and 3B. The sensor board 210B is configured to measure audio signal 215B from the environment as experienced by the physical mass, in addition to the vibration signals 215A as described above with respect to FIG. 4A. Audio signals 215B may be produced by various aspects of the surrounding environment such as those described above with respect to FIG. 4A.

In an example of the present disclosure with respect to FIG. 4B, the sensing board 210B further includes a microphone 211B, in addition to the accelerometer 211A as described above with respect to FIG. 4A. The Microphone 211B is configured to detect audio signals 215B and produce a voltage or impedance differential proportional to the measured audio signals experienced by the physical mass 100. In an example, the measured signal may be a musical audio signal. In another example, the measured signal may be a pacifying audio signal played to soothe an animal. In another example, the measured signal may be a distressing audio signal observed by an animal. In another example the measured audio signal may be environmental steady state noise. The microphone 211B may be one or more of MEMS microphone, Electret microphone, analog MEMs microphone, digital MEMS microphone and piezoelectric microphone. In an example, the microphone 211B is a MEMS microphone. The MEMS microphone may be configured to provide a voltage or impedance differential proportional to audio signals detected over a period of time. In some examples, the microphone 211B may be a combination of one MEMS microphone calibrated for low frequency audio signals and another MEMS microphone calibrated for higher frequency audio signals providing a broader coverage for audio signals.

The sensor board 210B further comprises a signal processing element 212B in addition to the signal processing element 212A as described above in the example with respect to FIG. 4A. The operation of the signal processing element 212B can be described similar to that of the signal processing system 212A. The environmental sensory profile determined by the processor 301 may include, in addition to the data described above with respect to FIG. 4A, a visual representation of the measured audio signal in the form of a waveform. The environmental sensory profile may also include a digitally processed audio signal to be played back from an external device upon retrieval from the processor 301. The environmental sensory profile may further provide a decibel level of the measured audio signal experienced by the physical mass 100.

FIG. 4C illustrates an example of the present disclosure including a sensing board 210C. The sensor board 210C retains the same processing system 300 and power supply 400 as described above in the example with respect to FIGS. 1A and 3B. The sensor board 210C is configured to measure an Optical signal 215C from the environment as experienced by the physical mass 100, in addition to the vibration signals 215A as described above with respect to FIG. 4A. Optical signals 215C may be light rays produced by various aspects of the surrounding environment as experienced by the physical mass 100. Detecting and controlling light exposure to lab animals, notably during the dark phase or night phase may significantly improve the natural behavior and physiology of lab animals. Further, maintaining a proper dark-light cycle is crucial for regulating mouse circadian rhythms. The optical signal 215C detected may be a brightness signal. The optical signal 215C detected may be a specific wavelength or wavelength range. As a non-limiting example, the optical signal 215C may be an ultraviolet signal visible to mice. Alternatively, the optical signal 215C may be infrared signal that is invisible to mice. Alternatively, the optical signal 215C may be red signal that may not be effectively visible to mice.

In an example of the present disclosure with respect to FIG. 4C, the sensing board 210C further includes an optical sensor 211C, in addition to the accelerometer 211A as described above with respect to FIG. 4A. The Optical sensor 211C is configured to detect optical signals 215C and produce a voltage or impedance differential proportional to the measured optical signals experienced by the physical mass 100. The optical sensor 211C may be a photodiode. The photodiode may be configured to provide a voltage or impedance differential proportional to the incident photons signals detected over a period of time. In one example, the photodiode may be a PN photodiode configured to detect brightness intensity in low-light conditions. Alternatively, the photodiode may be an avalanche photodiode configured to detect brightness intensities in ultra-lowlight conditions. In another example, the photodiode may be a PIN photodiode configured to detect optical signals 215C in high-speed conditions. In some examples, the photodiodes may be combined with an optical filter to remove specific low or high wavelengths. The optical filters may also be configured to pass light with a specific wavelength range.

The sensor board 210C further comprises a signal processing element 212C in addition to the signal processing element 212A as described above in the example with respect to FIG. 4A. The operation of the signal processing element 212C can be described similar to that of the signal processing system 212A. The environmental sensory profile determined by the processor 301 may include visual representation of the measured optical signals in the form of a waveform, in addition to the data described above with respect to FIG. 4A. The environmental sensory profile may also include a spectral waveform of the optical signals 215C experienced by the physical mass 100. The environmental sensory profile may also include brightness intensities of the optical signals 215C experienced by the physical mass 100.

FIG. 4D illustrates an example of the present disclosure including a sensing board 210D. The sensor board 210D retains the same processing system 300 and power supply 400 as described above in the example with respect to FIGS. 1A and 3B. The sensor board 210D is configured to measure a temperature signal 215D from the environment as experienced by the physical mass, in addition to the vibration signals 215A as described above with respect to FIG. 4A. Temperature signals 215D may be the temperature of the surrounding environment as experienced by the physical mass 100.

In an example of the present disclosure with respect to FIG. 4D, the sensing board 210D further includes a temperature sensor 211D, in addition to the accelerometer 211A as described above with respect to FIG. 4A. The temperature sensor 211D is configured to detect temperature signals 215D and produce a voltage or impedance differential proportional to the measured temperature signals experienced by the physical mass 100. The temperature sensor 211D may be a thermocouple. The thermocouple may be configured to provide a voltage or impedance differential proportional to the incident absolute temperature signals detected over a period of time. In one example, the thermocouple may be an analog sensor. In another example, the thermocouple may be digitized.

The sensor board 210D further comprises a signal processing element 212D in addition to the signal processing element 212A as described above in the example with respect to FIG. 4A. The operation of the signal processing element 212D can be described similar to that of the signal processing system 212A. The environmental sensory profile determined by the processor 301 may include visual representation of the measured temperature signals in the form of a heatmap, in addition to the data described above with respect to FIG. 4A. The environmental sensory profile may also include a graphical representation of the measured temperature signals over a period of time, as experienced by the physical mass 100.

FIG. 5 illustrates a block diagram of a sensor board 220 according to an example of the present disclosure. The sensor board 220 retains the same processing system 300 and power supply 400 as described above in the example with respect to FIGS. 1A and 3B. The sensor board 220 is configured to measure one or more of a vibration signal 215A, an audio signal 215B, an Optical signal 215C, and a temperature signal 215D from the environment as experienced by the physical mass 100. The environmental factors 215A-215D may be as described herein with respect to FIG. 4A-4D.

In an example of the present disclosure with respect to FIG. 5, the sensing board 220 further includes a sensor hub 221 comprising an accelerometer 221A, a microphone 221B, an optical sensor 221C and a temperature sensor 221D. The sensing elements 221A-221D are configured to detect environmental factors 215A-215D simultaneously and produce a voltage or impedance differential proportional to the measured environmental factors or signals experienced by the physical mass 100, similar to the sensing elements 211A-211D explained herein with respect to FIG. 4A-4D.

The sensor board 220 further comprises a signal processing element 222 which includes signal processing sub-elements 222A-222D. The operation of the signal processing sub-elements 222A-222D can be described similar to that of the signal processing element 211A-211D. The environmental sensory profile determined by the processor 301 may include visual representation of the measured environmental factors as experienced by the physical mass 100, as detailed herein with respect to FIG. 4A-4D.

The examples discussed above with respect to FIGS. 4A-4D and 5 are intended for the purpose of describing examples of this technology and in no way is intended to be limiting. While examples described in FIGS. 4B-4D and 5, disclose preferred sensor combinations with the accelerometers in the sensor board, other sensors may also be used depending on the environment that the environmental sensing system 10 is deployed into. For example, the environmental sensing system 10 may include, in addition to the accelerometer 211A, one or more of strain sensors, stress sensors, volumetric sensor, torque sensors, shear sensors, chemical sensors, biological sensors, neural sensors, pressure sensors, barometric pressure sensors, vacuum sensors, altimeters, conductivity sensors, impedance sensors, inertial measurement units, force sensing resistors, laser range finders, acoustic range finders, magnetometers, Hall Effect sensors, magneto-diodes, magneto-transistors, MEMS magnetic field sensors, gyroscope sensors, flow sensors, humidity sensors, chemiresistors, volatile organic compound sensors, heavy metal sensors, pH sensors, sedimentation sensors, cardiac ablation sensors, myoelectric sensors, electronic noses, gas sensors, oxygen sensors, nitrogen sensors, natural gas sensors, VX gas sensors, sarin gas sensors, mustard gas sensors, explosives detectors, metal detectors and radiological detectors.

Any of the examples of the sensor boards described herein with respect to FIG. 3-5 may be coupled to any of the physical mass 100, 100A, 100B and 100C morphologically modelled after the mouse, described herein with respect to FIGS. 1A, 1B, 2A and 2B. As described above, while the mouse is used as an exemplary non-human living organism for the modelling of the physical mass 100, other organisms such as chicken, fruit fly, worm, rat, zebrafish, frog, rabbit, swine, or non-human primates may also be used and any physical mass modelled after any of these organisms may be coupled with, for example, any of the sensor boards described herein with respect to FIG. 3-5. In some examples, the processing system and the sensor board may be connected by means of a flexible printed circuit (FPC) cable or the like. In other examples, the processing system and the sensor board may be connected by means of a copper cable or the like. In other examples, the sensor or sensors may be coupled to a cloud computing system configured to implement examples of this technology as illustrated and described herein.

In an example of the environmental sensing system described with respect to FIGS. 1A, 1B, 2A and 2B, the sensor board may be coupled to the physical mass 100 by means of an adhesive, stitching sutures, or other means readily understood by a person of ordinary skill level in the art. The sensing element may be coupled to selected portions of the physical mass 100 or coupled to the entire physical mass 100 as illustrated in FIG. 1A. As may be appreciated by a person of ordinary skill level in the art, the positioning of the sensing element on the physical mass 100 be advantageous in detecting resonant frequency or an RFR experienced by the whole body of the mouse. In an example, the sensing element may be coupled to a head portion of the physical mass 100 modelled after the head of the mouse as illustrated in FIG. 2A. As may be appreciated by a person of ordinary skill level in the art, the positioning of the sensing element on the head portion may be advantageous in detecting resonant frequency or a RFR locally experienced by the head of the mouse independent of the rest of the body. In another example, the sensing element may be coupled to a back-side portion of the physical mass 100 modelled after the back-side portion of the mouse as illustrated in FIG. 2B. As may be appreciated by a person of ordinary skill level in the art, the positioning of the sensing element on the back-side portion may be advantageous in detecting resonant frequency or a RFR locally experienced by the back-side of the mouse independent of the rest of the body.

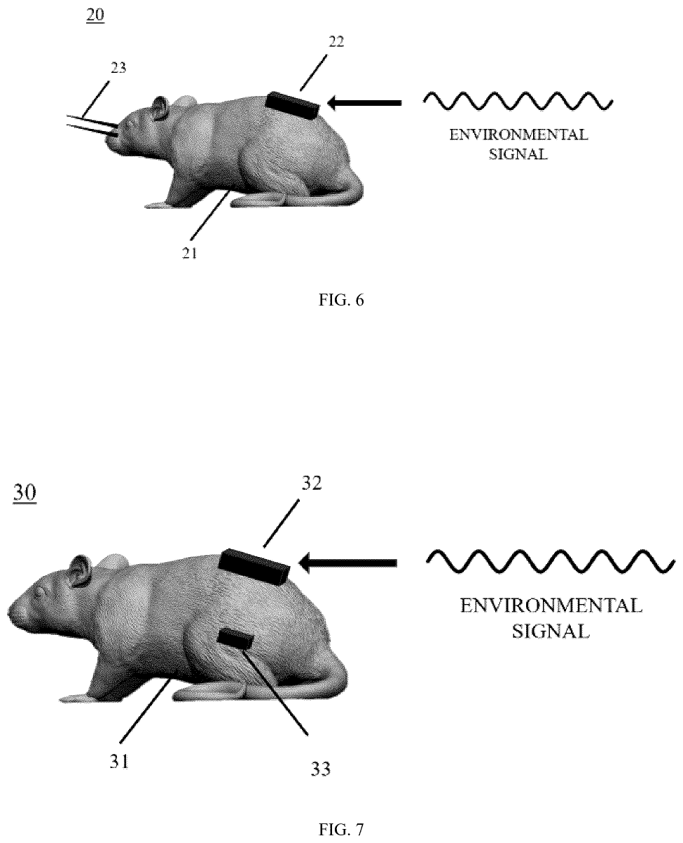

FIG. 6 illustrates an environmental sensing system 20 according to yet another example of this technology. In this example, a sensor board 22, similar to the sensor boards described herein with respect to FIG. 3-5 may be positioned on the physical mass 21 compositionally similar to physical mass as described herein with respect to FIGS. 1A, 1B, 2A, and 2B. Additionally, this example includes a biomimetic vibration sensor 23, shaped like a mouse whisker, positioned on the head portion of the physical mass 21. The addition of this biomimetic sensor is advantageous in that this allows to more closely replicate the detection of subtle vibration changes detected by a mouse using its whiskers.

FIG. 7 illustrates an environmental sensing system 30 according to yet another example of this technology. In this example, a sensor board 32, similar to the sensor boards described herein with respect to FIG. 3-5 may be positioned on the physical mass 31 compositionally similar to physical mass as described herein with respect to FIGS. 1A, 1B, 2A, and 2B. Additionally, this example includes an additional vibration sensor 33 similar to the sensor board 210A described herein with respect to FIG. 4A, placed inside of the physical mass 31. As a non-limiting example, the vibration sensor 33 may be placed inside the physical mass 31 in a portion morphologically similar to a uterus of a mouse. The measured vibration signals from the vibration sensor 33 may be compared with the vibration signals measured by the sensor board 32 at the processor to determine the vibration transferred form the surface of the physical mass 31 to the uterus portion of the physical mass 31. This vibration difference may be advantageous in understanding multigenerational animal research, especially since research indicates that vibrations are some of the first stimulus that developing nervous systems of a fetus respond to.

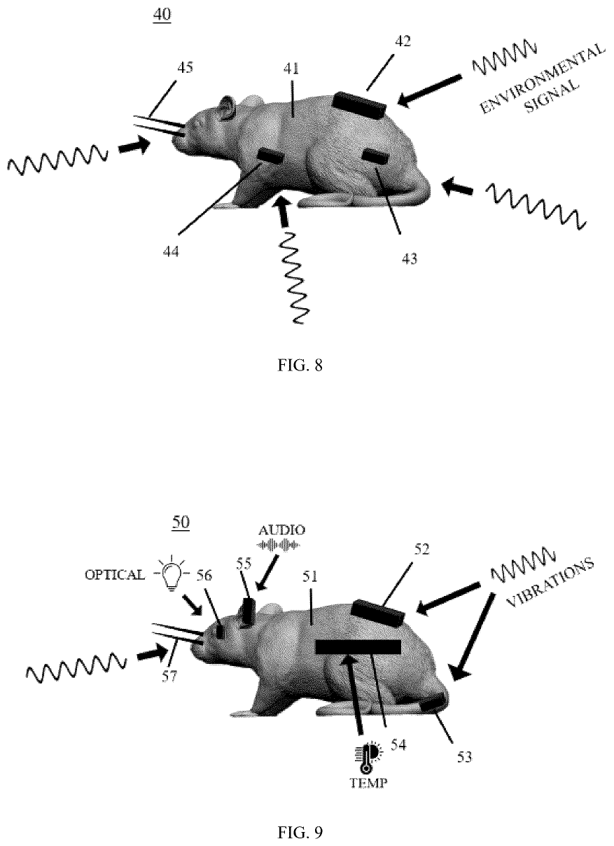

FIG. 8 illustrates an environmental sensing system 40 according to yet another example of this technology. In this example, a sensor board 42, similar to any of the sensor boards described herein with respect to FIG. 3-5 may be positioned on the physical mass 41 compositionally similar to physical mass as described herein with respect to FIGS. 1A, 2A, and 2B. Additionally in this example a plurality of sensing elements 43, 44 and 45 are positioned on and coupled to different portions of the physical mass. In an example, the sensing elements may be connected to the sensor board 42 and share the same processing system according to the examples disclosed herein, positioned on the sensor board 42. Alternatively, the processing system may be coupled to the physical mass directly and outside the sensor board 42, and further coupled with the sensing elements of sensor board 42 and the other sensing elements 43, 44, and 45. The sensing elements 43, 44 and 45 may be connected to the sensor board 42 through FPC cables or other wired connection cables. Alternatively, the sensing elements 43, 44 and 45 may be connected to the sensor board 42 by means of wireless transmission protocols such as Bluetooth, Bluetooth Low Energy (BLE), LTE, LTE-M, zigbee, Wi-Fi, low frequency and high frequency RFID, LoRaWAN, 6LoWPAN, Z-Wave, NB-IoT, and NFC. It may now be understood that the environmental sensing system 40 includes a network of sensing elements 42, 43, 44 and 45 positioned at different positions of the physical mass 41 around the body. The network of sensing elements is configured to detect environmental factors 46 and a processor coupled to the sensing elements receives the measured environmental signals from the sensing elements 42, 43, 44 and 45, and determines an environmental sensing profile as described in examples herein with respect to FIG. 3-5.

FIG. 9 illustrates an environmental sensing system 50 according to yet another example of this technology. In this example, the physical mass 51 compositionally similar to physical mass described herein with respect to FIGS. 1A, 1B, 2A and 2B. The physical mass 51 is additionally designed to include a network of embedded sensing elements 52-57 strategically in various positions on the physical mass 51 to specifically mimic the physiological sensing mechanisms of a mouse. A mouse detects light signals with its eyes, detects audio signal with ears, detects vibrations with a combination of at least whiskers, tail and skin, detects environmental temperature and humidity using skin surface. The physical mass 51 is designed to include an embedded photodiode 56, positioned on the eye region, configured to detect various optical signals as disclosed herein. The physical mass 51 is designed to include an embedded biomimetic sensing element 57, positioned on the nose region, modelled after mouse whiskers and configured to detect vibration signals as disclosed herein. The physical mass 51 is designed to include an embedded microphone 55, positioned on the ear region, configured to detect various audio signals as disclosed herein. The physical mass 51 is designed to include an embedded temperature sensor 54, positioned on skin surface region, configured to detect environmental temperature signals as disclosed herein. The physical mass 51 is designed to include embedded accelerometers 52 and 53, positioned on the back-side region and tail region respectively, configured to detect environmental vibrations as disclosed herein. The sensing elements 52-57 may be connected to the processing system through FPC cables or other wired connection cables. Alternatively, the sensing elements 52-57 may be connected to the processing system 300 by means of wireless transmission protocols such as Bluetooth, Bluetooth Low Energy (BLE), LTE, LTE-M, zigbee, Wi-Fi, low frequency and high frequency RFID, LoRaWAN, 6LoWPAN, Z-Wave, NB-IoT, and NFC.

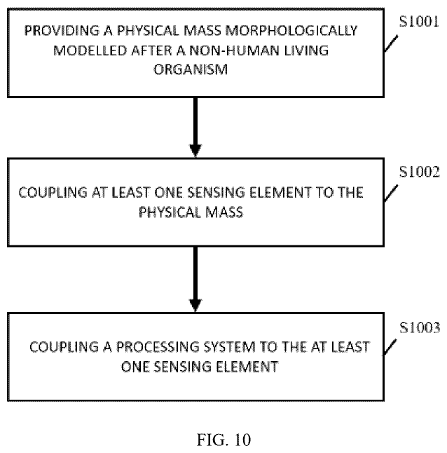

FIG. 10 illustrates a method of manufacture of an environmental sensing system according to yet another example of the present invention. The first step S1001 of the example includes providing a physical mass morphologically modelled after a non-human living organism to mimic at least one attribute of the non-human living organism. In this example, the physical mass is particularly modelled to replicate the resonant frequency of the body of a mouse. The physical mass according to examples disclosed herein with respect to FIGS. 1A, 1B, 1D, 2A, 2B, 6-9 are described as modelled after a mouse merely for the purpose of simplifying the description example of this technology and is not meant to be limiting. The physical mass may be modelled after other animals as disclosed herein with respect to examples above. The physical mass may be morphologically modelled to replicate at least one of the attributes, such as size, shape, mass or mass distribution of the mouse, to produce the same resonant frequency as that of the body of a mouse. The physical mass may be modelled to replicate the density of the mouse. The physical mass may be modelled to replicate the flexibility of the mouse. The physical mass may be modelled to replicate the center of gravity distribution of a mouse and so on. Other physical parameters in the body of a mouse may be replicated in the physical mass, as understood by a person of ordinary skill level, to achieve the replication of the resonant frequency produced by the body of a mouse in the physical mass.

The second step S1002 of the example includes coupling at least one sensing element to the physical mass. The sensing elements according to examples disclosed herein with respect to FIGS. 3-5 are configured to detect environmental signals experienced by the physical mass morphologically modelled after a mouse. The sensor board may be coupled to the physical mass by means of an adhesive, stitching sutures, or other means readily understood by a person of ordinary skill level in the art. The sensing element may be coupled to selected portions of the physical mass or coupled to the entire physical mass as illustrated in FIG. 1A. As may be appreciated by a person of ordinary skill level in the art, the positioning of the sensing element on the physical mass be advantageous in detecting resonant frequency or a RFR experienced by the whole body of the mouse. In an example, the sensing element may be coupled to a head portion of the physical mass modelled after the head of the mouse as illustrated in FIG. 2A. As may be appreciated by a person of ordinary skill level in the art, the positioning of the sensing element on the head portion may be advantageous in detecting resonant frequency or a RFR locally experienced by the head of the mouse independent of the rest of the body. In another example, the sensing element may be coupled to a back-side portion of the physical mass modelled after the back-side of the mouse as illustrated in FIG. 2B. As may be appreciated by a person of ordinary skill level in the art, the positioning of the sensing element on the back-side portion may be advantageous in detecting resonant frequency or a RFR locally experienced by the back-side of the mouse independent of the rest of the body. As described with respect to FIGS. 6-9, the sensing elements may be coupled in a distributed manner as a network across the physical mass, or positioned inside the physical mass.

The third step S1003 of the example includes coupling a processing system to the at least one sensing element. The processing system includes a processor and memory as described in examples with respect to FIG. 3B. The processing system is configured to execute programmed instructions stored in memory to receive the measured effect of an environmental signal from the sensing element and determine an environmental sensory profile based on the measured effect. The environmental sensory profile may be a visual representation of the data of the measured effect detected by the sensing element in a context understood by human users.

As a non-limiting example, the environmental sensory profile may provide a frequency or a range of frequencies in hertz experienced by the physical mass 100 over a set time period. As a non-limiting example, the environmental sensory profile may provide an amplitude of the measured audio wave in volts. As another non-limiting example, the environmental sensory profile may provide a graphical representation of the amplitude of the measured vibrations or a frequency of the measured vibrations or a combination of both. In one aspect of the example, the environmental sensory profile may provide a time domain amplitude response of the measured vibrations and in other aspects, the environmental sensory profile may provide a frequency domain amplitude response of the measured vibrations or a combination of both. As appreciated by one of ordinary skill level in the art, a time domain amplitude response may be a graphical representation of the variation of measured vibration amplitude or audio wave amplitude over a period of time, and a frequency domain amplitude response may be a graphical representation of the variation of measured vibration amplitude or audio wave amplitude over a range of frequencies. In some examples, the environmental sensory profile may provide a heat map from the measured temperatures of the surrounding environment.

While these examples of this technology contain many specifics, these should not be construed as limitations on the scope of what is claimed or of what may be claimed, but rather as mere descriptions of features specific to particular examples. Certain features that are described in this document in the context of separate examples can also be implemented in combination in a single example. Conversely, various features that are described in the context of a single example can also be implemented in multiple examples separately or in any suitable sub combination.

Only a few examples and implementations are disclosed. Variations, modifications, and enhancements to the described examples and implementations and other implementations can be made based on what is disclosed.

What is claimed is:

1. An environmental sensing system for a non-human living organism comprising:
a physical mass morphologically modelled after at least a part of a non-human living organism to mimic at least one attribute of the non-human living organism;
at least one sensing element coupled to and configured to measure an effect of at least one environmental factor on the physical mass, wherein the at least one sensing element is configured to output the one or more measurements of the effect of the least one environmental factor on the physical mass to enable a determination of an environmental sensory profile as experienced by the physical mass.

2. The system as set forth in claim 1 wherein the physical mass has two or more portions which are each morphologically modelled after different parts of the non-human living organism.

3. The system as set forth in claim 1 wherein the at least one attribute comprises a size, a shape, a mass or a mass distribution of the at least a portion of the non-human living organism.

4. The system as set forth in claim 1, wherein the at least one sensing element comprises at least one of an accelerometer, a biomimetic sensor, a microphone, an optical sensor, a temperature sensor, a chemical sensor, or a humidity sensor.

5. The system as set forth in claim 4, wherein the accelerometer is a triaxial Micro Electromechanical Sensor (MEMS) accelerometer.

6. The system as set forth in claim 5, wherein the accelerometer is a combination of a piezoelectric accelerometer and a triaxial MEMS accelerometer.

7. The system as set forth in claim 1, where the at least one sensing element comprises a network of sensing elements coupled to the processing system and coupled to different sensing elements disposed in different positions on and/or inside the physical mass.

8. The system as set forth in claim 1 wherein the environmental effect comprises vibration and the measured effect comprises a resonant frequency of at least the portion of the non-human living organism.

9. The system as set forth in claim 1, wherein the resonant frequency comprises a whole-body Resonant Frequency Range (RFR) of the non-human living organism.

10. The system set forth in claim 1, wherein the physical mass is modelled after one of a mouse, chicken, fruit fly, worm, rat, zebrafish, frog, rabbit, swine, or non-human primate.

11. The system set forth in claim 1, wherein the physical mass is modelled to replicate at least one of density, flexibility, center of gravity, mass, stiffness, elasticity, size, shape, and weight distribution of the non-human living organism.

12. The system set forth in claim 1, wherein the physical mass includes one or more automated joints to produce movements mimicking the natural movements produced by the body of the non-human living organism.

13. A method of manufacture of an environmental sensing system for a non-human living organism, the method comprising:
providing a physical mass morphologically modelled after at least a part of a non-human living organism to mimic at least one attribute of the non-human living organism; and
coupling at least one sensing element to the physical mass, the at least one sensing element configured to measure an effect of at least one environmental factor on the physical mass, wherein the at least one sensing element is configured to output the one or more measurements of the effect of the least one environmental factor on the physical mass to enable a determination of an environmental sensory profile as experienced by the physical mass.

14. The method as set forth in claim 13, wherein the physical mass modelled after at least a part of a non-human living organism is made using ballistic gel.

15. The method as set forth in claim 13, wherein the physical mass has two or more portions which are each morphologically modelled after different parts of the non-human living organism.

16. The method as set forth in claim 13, wherein the at least one attribute comprises a size, a shape, a mass or a mass distribution of the at least a portion of the non-human living organism.

17. The method as set forth in claim 13, wherein the at least one sensing element comprises at least one of an accelerometer, a biomimetic sensor, a microphone, an optical sensor, a temperature sensor, a chemical sensor, or a humidity sensor.

18. The method as set forth in claim 17, wherein the accelerometer is a triaxial Micro Electromechanical Sensor (MEMS) accelerometer.

19. The method as set forth in claim 18, wherein the accelerometer is a combination of a piezoelectric accelerometer and a triaxial MEMS accelerometer.

20. The method as set forth in claim 13, wherein the at least one sensing element comprises a network of sensing elements coupled to the processing system and coupled to different sensing elements disposed in different positions on and/or inside the physical mass.

21. The method as set forth in claim 13, wherein the environmental effect comprises vibration and the measured effect comprises a resonant frequency of at least the portion of the non-human living organism.

22. The method as set forth in claim 13, wherein the resonant frequency comprises a whole-body Resonant Frequency Range (RFR) of the non-human living organism.

23. The method set forth in claim 13, wherein the physical mass is modelled after one of a mouse, chicken, fruit fly, worm, rat, zebrafish, frog, rabbit, swine, or non-human primate.

24. The system set forth in claim 13, wherein the physical mass is modelled to replicate at least one of density, flexibility, center of gravity, mass, stiffness, elasticity, size, shape, and weight distribution of the non-human living organism.

25. The method set forth in claim 13, wherein the physical mass includes one or more automated joints to produce movements mimicking the natural movements produced by the body of the non-human living organism.
